(19) United States
(12) Patent Application Publication
(10) Pub. No.: US 2012/0216355 A1
(43) Pub. Date: Aug. 30, 2012

(54) DYE-CHARGED PARTICLES

(75) Inventor: Ezekiel Kruglick, Poway, CA (US)

(73) Assignee: Empire Technology Development LLC, Wilmington, DE (US)

(21) Appl. No.: 13/386,390

(22) PCT Filed: Feb. 25, 2011
(86) PCT No.: PCT/US11/26331

§ 371 Date: Jan. 20, 2012

(51) Int. Cl. D06P 5/20; B65D 69/00; B05D 7/00

(52) U.S. Cl. 8/467; 427/222; 427/212; 206/575

(57) ABSTRACT

Methods, compositions, and systems for dyeing textiles are described. In particular, the methods may include contacting a textile with a plurality of dye-charged particles under dye-discharging conditions, agitating the textile and the dye-charged particles to transfer the dye from the particles to the textile, and separating the particles from the textile. Also disclosed are methods for charging a particle with dye, porous beads charged with dye, and kits for carrying out the claimed methods.

### BACKGROUND

Water usage at textile mills can generate millions of gallons of dye wastewater daily. This water usage adds substantially to the cost of finished textile products through the cost of fresh water and sewer discharge. Additionally, wastewater from textile dyeing processes imposes substantial pollutant loads on downstream water treatment systems due to high levels of dyes, chemical oxygen demand, biological oxygen demand, and suspended solids.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIGS. 1A and 1B are a pair of schematic diagrams illustrating two types of particles charged with dye: a porous bead charged with dye (FIG. 1A), and a polymer particle charged with dye (FIG. 1B)

FIGS. 2A-2D are a series of flow diagrams illustrating some of the operations associated with example methods for dyeing a textile

FIG. 3 is a flow diagram illustrating some of the operations associated with an example method for charging a particle with dye

FIG. 4 is a schematic diagram illustrating a kit for dyeing a textile.

### SUMMARY

Disclosed herein in various embodiments are methods for dyeing a textile. In some embodiments, the method may include the steps of contacting a textile with a plurality of dye-charged particles under dye-discharging conditions, agitating the textile and the dye-charged particles to transfer the dye from the particles to the textile, and separating the particles from the textile. In some examples of the method, the particles may include porous beads, for instance those made from sintered metal, clay, or controlled pore glass. In other examples of the method, the particles may include polymer particles, such as those made from polyamides, polyalkenes, polyester, polyurethane, or a copolymer thereof.

Other embodiments are methods of charging a particle with dye. In various embodiments, the methods may include the steps of contacting a polymer particle or porous bead with a dye in an aqueous solution that includes less than about 25% (w/w) water, and heating the polymer particle or porous bead and the dye at a temperature of about 30-90° C. In some examples of the method, the polymer particle may include a polyalkene, a polyester, a polyurethane, or a copolymer thereof, or an interpenetrating polymer network (IPN). In other examples of the method, porous bead may include a sintered metal, a clay, or a controlled pore glass.

Still other embodiments are porous beads for use in dyeing a textile. In various embodiments, the porous bead may be charged with an aqueous dye, a polyester dye, or a lipid-based dye. Some examples of the beads may include a sintered metal, a clay, or a controlled-pore glass.

Further embodiments are kits for dyeing a textile. In various embodiments the kit may include a container that includes a plurality of dye-chargeable particles, a container that includes a textile dye, and instructions for using the kit.

The foregoing summary is illustrative only and is not intended to be in any way limiting. In addition to the illustrative aspects, embodiments, and features described above, further aspects, embodiments, and features will become apparent by reference to the drawings and the following detailed description.

### DETAILED DESCRIPTION OF DISCLOSED EMBODIMENTS

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

As used herein, the term “sodium alginate” refers to an anionic polysaccharide that is commonly derived from sea algae, though it may also be produced by bacteria. In embodiments, an aqueous solution of alginate may be transformed into a hydrogel by the addition of one or more metallic divalent cations, such as, but not limited to Ca²⁺, Cu²⁺, Co²⁺, Mn²⁺, Mg²⁺, Pb²⁺, Zn²⁺, Ni²⁺, or Cd²⁺.

As used herein, the term “3-(methacrylamido) propyl trimethyl ammonium chloride” or “MAPTAC” refers to a cationic monomer. Polymerization of MAPTAC produces the polymer PMAPTAC, which has a N⁺(CH₃)Cl⁻ on the polymer chain.

As used herein, the term “polyalkene” refers to a polymer produced from a simple olefin (also called an alkene, with the general formula CₙH₂ₙ) as a monomer.

As used herein, the term “polyester” refers to a category of polymers that contain the ester functional group in their main chain. Although there are many polyesters, the term “polyester” as a specific material most commonly refers to polyethylene terephthalate.

As used herein, the term “polyurethane” refers to a polymer consisting of a chain of organic units joined by urethane (carbamate) links. Polyurethane polymers are formed through step-growth polymerization by reacting a monomer containing at least two isocyanate functional groups with another monomer containing at least two hydroxyl groups in the presence of a catalyst.

As used herein, the term “nylon” refers to a condensation copolymer formed by reacting equal parts of a diamine and a dicarboxylic acid, so that peptide bonds form at both ends of each monomer in a process analogous to polypeptide biopolymers. The numerical suffix specifies the numbers of carbons donated by the monomers; the diamine first and the diacid second. The most common variant is nylon 6-6 which refers to the fact that the diamine (1,6-diaminohexane) and the diacid (hexane-1,6-dicarboxylic acid) each donate 6 carbons to the polymer chain.

As used herein, the term “acrylamide” refers to a chemical compound having the formula C₃H₅NO.

As used herein, the term “dye-charging” refers to the process of loading a bead, particle, or other porous or non-porous material with dye. In various embodiments, a “dye-charged” material may carry the dye on the surface or in an interior space, for instance in one or more surface pores, in one or more interior pores, in a hollow center, or a combination thereof.

Methods, compositions, and systems for dyeing textiles are described. In various embodiments, methods and systems are provided that may greatly reduce or eliminate the production of contaminated wastewater in the dyeing process. Embodiments include, but are not limited to, methods, compositions, and kits. Other embodiments also may be disclosed and claimed. In some embodiments, the methods may include contacting a textile with a plurality of dye-charged particles under dye-discharging conditions, agitating the textile and the dye-charged particles to transfer the dye from the particles to the textile, and separating the particles from the textile.

In some embodiments, the particles may include but are not limited to porous materials, for instance, beads or particles made from, in non-limiting examples, sintered metals, clay, or controlled pore glass among others. For example, in some embodiments, the porous materials may have one or more surface pores, one or more interior pores, a hollow center or other aperture, or a combination thereof. As discussed in greater detail below, such particles may have any size or shape that allows the particles to contact a textile, and in some embodiments, the particles may be of a size and/or shape that permits them to intermingle with one or more textile fibers.

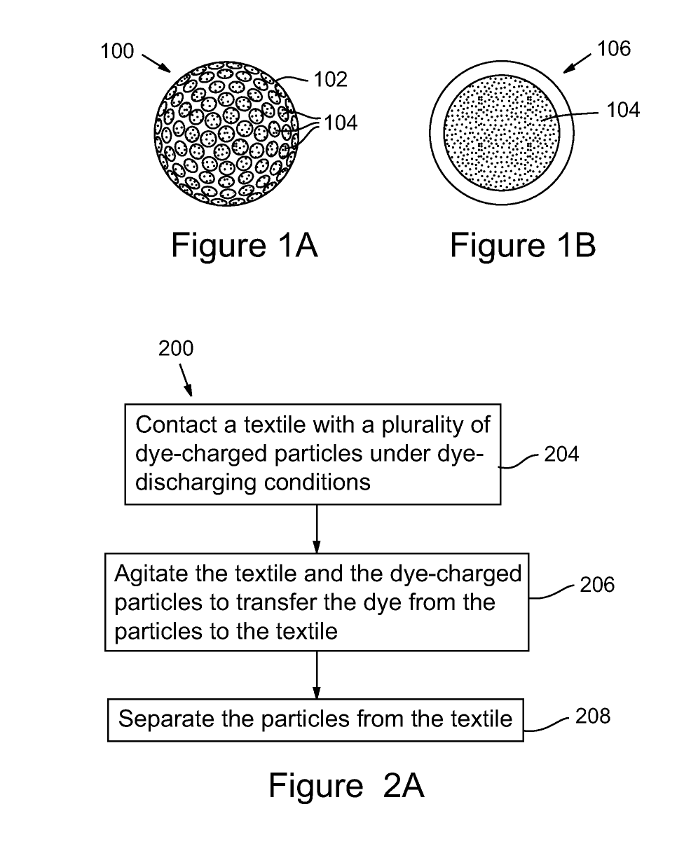

FIG. 1A is a schematic diagram illustrating a porous bead charged with dye. Referring to FIG. 1A, the bead 100 may have a plurality of surface pores 102 that may be charged with dye 104. In embodiments, porous bead 100 may have a pore size of from about 1 micron to about 500 microns, and in particular embodiments, the porous bead 100 may have a pore size of from about 5 microns to about 450 microns, for instance from about 10 microns to about 425 microns, from about 20 microns to about 375 microns, from about 30 microns to about 325 microns, from about 40 microns to about 275 microns, from about 50 microns to about 225 microns, from about 60 microns to about 175 microns, or from about 70 microns to about 125 microns. In general, porous beads made of sintered metals or clay may have a wide distribution of pore sizes, whereas controlled pore glass beads may have a more uniform pore size. As discussed below in greater detail, a porous bead 100 having a desired pore size may be selected for the particular textile being dyed or the particular dye used. In some embodiments, a pore size of a given particle or bead is generally smaller than the particle or bead itself, and, as discussed in greater detail below, may be selected to be greater than the pore size of the textile, for instance to facilitate dye transfer from particle to textile by capillary action.

In various embodiments, the particles or beads may have any shape that allows good flowability (e.g., they tumble and flow easily when agitated either mechanically, by moving air, or by another force) and intimate contact with the textile fiber (e.g., they are sized and shaped to be able to at least partially penetrate a weave or fiber pattern of the material). This may include, for instance, oblongs, discs, spheres, cubes, cylinders, or the like. In one specific, non-limiting embodiment, the particles may have a cylindrical shape, for instance, having a diameter of from about 1 mm to about 20 mm, or more particularly, from about 4 mm to about 17 mm, from about 5 mm to about 16 mm, from about 8 mm to about 13 mm, or from about 10 mm to about 11 mm; and a length of from about 1 mm to about 20 mm, or more particularly, from about 2 mm to about 19 mm, from about 5 mm to about 16 mm, from about 7 mm to about 14 mm, or from about 9 mm to about 12 mm. In specific embodiments, the cylindrical particles may have an average mass of from about 10 mg to about 10 g, or more particularly, from about 20 mg to about 9 g, from about 50 mg to about 7 g, from about 100 mg to about 5 g, from about 150 mg to about 3 g, from about 180 mg to about 1 g, from about 250 mg to about 800 mg, or from about 300 mg to about 700 mg.

In various embodiments, the porous beads may be charged with dye, for instance, a solid, semi-solid, gel, or liquid dye, by contacting the beads with the dye under appropriate dye-charging conditions. As used herein, the term “dye-charging conditions” refers to a set of conditions, for instance temperature and/or humidity, designed to facilitate uptake of the dye into the pores of the beads. For instance, in some embodiments, a particular temperature and/or humidity may be selected based on the type of dye used, the size and type of pores in the particles and/or textile, and/or the type of material being dyed. In one specific, non-limiting example, the porous beads may be mixed with the dye at an elevated temperature, for instance, from about 30-90° C. Without being bound by theory, the elevated temperature may cause the dye to soften, liquefy, dissolve, or melt, and may facilitate absorption of the dye (for instance, by capillary action) by the pores of the porous beads. In some embodiments, a successful dye-charging process may be indicated by a color change in the particles as the dye is drawn into the pores, or a reduction in the volume or mass of free (uncharged) dye remaining after the dye-charging process.

In embodiments, it is believed that allowing the dye-charged porous beads to cool (for instance, to about room temperature) may allow the dye to congeal in the surface pores, which is believed to aid in retention of the dye in the beads until they are later brought into contact with a textile under dye-discharging conditions. Additionally, it is believed that a surface tension effect may be created in the porous beads that may cause the pores of the beads to retain the dye until it is later wicked by contact with the textile, according to various embodiments.

In some embodiments, the dye may be an aqueous dye, whereas in other embodiments, the dye may be a polyester-based dye, a lipid-based dye, or a dye that is soluble in organic solvents, such as alcohol or oil-based dyes, for instance aniline dyes, or anthraquinone-based dyes. A number of other dye types may be used, as well. For instance, in some embodiments, the dye may be an acid dye, a basic dye, a direct or substantive dye, a mordant dye, a vat dye, a reactive dye, a disperse dye, or a sulfur dye, each of which is discussed briefly below.

Acid dyes are water-soluble anionic dyes that may be used for dyeing fibers such as silk, wool, nylon and modified acrylic fibers using neutral to acid conditions.

Basic dyes are water-soluble cationic dyes that may be used for dyeing acrylic fibers, wool, and silk.

Direct or substantive dyeing may be carried out in neutral or slightly alkaline conditions, for instance at or near the dye boiling point, with the addition of, for instance, either sodium chloride (NaCl) or sodium sulfate (Na₂SO₄). In various embodiments, direct dyes may be used on cotton, paper, leather, wool, silk, nylon, and the like.

Mordant dyes make use of a substance used to set the dye, which improves the fastness of the dye against water, light, and perspiration. Most natural dyes are mordant dyes, and synthetic mordant dyes (also known as chrome dyes) are often used for wool and wool-like fibers. One specific, non-limiting example of a mordant is potassium dichromate, and many mordants are heavy metals.

Vat dyes are essentially insoluble in water, but reduction in alkaline liquor may produce the water soluble alkali metal salt of the dye, which has an affinity for textile fibers. Subsequent oxidation re-forms the original insoluble dye. One specific, non-limiting example of a vat dye is indigo.

Reactive dyes may utilize a chromophore attached to a substituent that is capable of directly reacting with the fiber substrate. The covalent bonds that attach reactive dyes to natural fibers make them among the most permanent of dyes. “Cold” reactive dyes, such as Procion MX™, Cibacron F™, and Drimarene K™, may be applied at room temperature.

Disperse dyes are water insoluble, and may be finely ground in the presence of a dispersing agent and used as a paste or spray-dried and used as a powder. In various embodiments, they may be used to dye polyester and similar fibers, but they may also be used to dye nylon, cellulose triacetate, and acrylic fibers. In some embodiments, a dyeing temperature of about 130° C. may be used for disperse dyes.

Sulfur dyes are two part “developed” dyes that, in some embodiments, may be used to dye cotton with dark colors. The initial bath imparts a yellow or pale chartreuse color, and this is after-treated with a sulfur compound in place to produce a dark black color.

Specific, non-limiting examples of suitable dyes include, but are not limited to, Taiacryl Brilliant Red 4GN (C.I. Basic Red 14) and Reactive blue 19 (an anthraquinone dye).

Little or no water may be used when charging the beads with dye, according to various embodiments. For instance, in some examples, an aqueous dye may contain about 25% (w/w) water or less, for instance 22.5%, 20%, 17.5%, 15%, 12.5%, 10%, 7.5%, 5%, 2.5%, or even less water, and little or no additional water may be added during the dye-charging process. In other examples, the dye may be a polyester-based dye or a lipid-based dye, and the dye-charging process may require little or no additional water.

In some embodiments, the amount of water used for charging the beads with dye may be expressed as weight per liter. For example, in one specific, non-limiting example, for charging the polymer beads, 100 mg/L of Taiacryl Brilliant Red 4GN may be used. Specifically, in an embodiment, about 1-5 g of the beads may be added to 20 mL of (100 mg/L) dye in water. This may produce a volume of about 1-5 ml beads and 20 ml dye solution. In some specific examples, even less water may be used, for instance 15-20 ml beads and 5-10 ml water, particularly when agitation is used. Following agitation, the water may then be allowed to evaporate under dehumidifying conditions (for instance, either in the charging fluid or after removing them to a drier).

In various embodiments, the dye-charged particles may then be placed in contact with a textile, for instance a fiber, cloth, or yarn, under dye-discharging conditions. As used herein, the term “dye-discharging conditions” refers to conditions designed to cause the dye to be released from the particles. For example, “dye discharging conditions” may generally include any conditions that facilitate release of the dye from the particles and/or transfer of the dye from the particles to the textile, such as elevated temperature and/or low humidity, which may allow the dye to melt, soften, liquefy, or solubilize. For instance, in one example, the dye-discharging conditions may include a low relative humidity level, such as from about 0% to about 30% relative humidity, or, in particular examples, from about 2.5% to about 27.5% relative humidity, from about 5% to about 25% relative humidity, from about 7.5% to about 22.5% relative humidity, from about 10% to about 20% relative humidity, or from about 12.5% to about 17.5% relative humidity. In other embodiments, the dye-discharging conditions may include an elevated temperature, for instance from about 30° C. to about 90° C., from about 35° C. to about 85° C., from about 40° C. to about 80° C., from about 45° C. to about 75° C., from about 50° C. to about 70° C., or from about 55° C. to about 60° C. Without being bound by theory, the elevated temperature may facilitate melting, softening, liquefying, or solubilizing of the dye, which may, in turn, facilitate transfer of the dye from the porous bead to the textiles. In one specific, non-limiting example, for instance, the dye-discharging conditions may include tumbling or agitating the polymer beads with the textile at a temperature of from about 50° C. to about 60° C. at a very low level of humidity, for instance from about 0% to about 5% relative humidity.

In embodiments, the beads and textile may be agitated together (for instance, in a tumbling drum or on a fluidized bed to facilitate Newtonian flow) to facilitate intimate contact between the beads and the textile fibers. Without being bound by theory, it is believed that when the textile has a smaller average pore size than the average pore size of the beads, a capillary force gradient may be created that may wick the dye out of the porous beads and into the pores of the textile. Thus, in embodiments, a porous bead may be selected that has a larger average pore size than the average pore size of the fiber to be dyed. In particular embodiments, a dye-discharging temperature may be selected that may not permit the dye to be fully discharged from the beads without additional wicking action from the textile, for instance, by the capillary force gradient created with porous beads. Without being bound by theory, such a temperature may allow the dye to partially melt, soften, solubilize, or liquefy, but still be substantially retained by the porous particles until drawn out by capillary action when brought into contact with the textile.

In other embodiments, instead of sintered metals, clay, or controlled pore glass, the particles may include (or be made of) a polymer, for instance, a polyamide, a polyalkene, a polyester, a polyurethane, or a copolymer thereof. As described above in greater detail, the particles may have any size and shape that allows good flowability and intimate contact with the textile fiber, and the particles may have a pore size of from about 1 micron to about 500 microns. FIG. 1B is a schematic diagram illustrating a polymer particle 106 charged with dye 104. In specific, non-limiting examples, the polymer may be nylon, nylon 6, or nylon 6,6, for instance, a nylon 6,6 homopolymer. In particular embodiments, the nylon 6,6 homopolymer may have a molecular weight of from about 5,000 to about 30,000 Daltons. In other embodiments, the polymer may include an interpenetrating polymer network (IPN), for instance, an IPN that includes sodium alginate, acrylamide, K₂S₂O₈, N,N′-methylenebisacrylamide (MBAM), and/or 3-(Methacrylamido) propyl trimethyl ammonium chloride (MAPTAC).

In various embodiments, as with the particles made from sintered metals, clay, or controlled pore glass, the polymer particles may be charged with dye by contacting the particles with the dye under appropriate dye-charging conditions. For instance, in some embodiments, the polymer particles may be mixed with the dye at an elevated temperature, for instance, from about 30-90° C., such as from about 35° C. to about 85° C., from about 40° C. to about 80° C., from about 45° C. to about 75° C., from about 50° C. to about 70° C., or from about 55° C. to about 60° C. In some embodiments, drying the charged porous beads may help “lock in” the dye. In other embodiments, the dye may be mixed with the polymer particles in a moist environment, for instance, in an aqueous environment that includes from about 10% to about 25% water (or another polar solvent), such as from about 12.5% to about 22.5%, or from about 15% to about 20%.

In various embodiments, the dye-charged particles may then be placed in contact with a textile, for instance but not limited to a fiber, cloth, or yarn, under dye-discharging conditions. In some embodiments, such dye-discharging conditions may generally include a moist saline environment. In various embodiments, the salinity range may be large, and may range from about 0.5 parts per thousand (e.g. grams of salt per kilogram of solution) to about 300 parts per thousand. For instance, the salinity may be about 5, 10, 20, 40, 60 or 80 parts per thousand in specific, non-limiting examples.

In other specific, non-limiting examples of a moist saline environment, the ratio of the weight of the saline solution to the weight of the textile (e.g., the saline-to-textile ratio) may be from about 0.1:1 to about 5:1 weight to weight, for instance from about 0.2:1 to about 4.8:1; from about 0.4:1 to about 4.6:1; from about 0.6:1 to about 4.4:1; from about 0.8:1 to about 4.2:1; from about 1:1 to about 3:1; from about 1.2:1 to about 2.8:1; from about 1.4:1 to about 2.6:1; from about 1.6:1 to about 2.4:1; or from about 1.8:1 to about 2.2:1. In some embodiments, a different buffer solution may be substituted for the saline solution. Specific, non-limiting examples of suitable buffers include TAPS {[tris(hydroxymethyl)methyl]amino}propanesulfonic acid (TAPS), N,N-bis(2-hydroxyethyl)glycine (Bicine); tris(hydroxymethyl)methylamine (Tris); N-tris(hydroxymethyl)methylglycine (tricine), 4-2-hydroxyethyl-1-piperazineethanesulfonic acid (HEPES), tris(hydroxymethyl)methyl]amino}ethanesulfonic acid (TES), 3-(N-morpholino)propanesulfonic acid (MOPS), piperazine-N,N′-bis(2-ethanesulfonic acid) (PIPES), dimethylarsinic acid (cacodylate), saline sodium citrate (SSC), and 2-(N-morpholino)ethanesulfonic acid (MES). It is believed that the saline solution may displace the dye in the pores of the ionically-charged polymer particles, causing the dye to be emitted in the presence of the textile.

In other embodiments, instead of a moist saline environment, the dye-discharging conditions may include a low relative humidity level, such as from about 0% to about 30% relative humidity, or, in particular examples, from about 2.5% to about 27.5% relative humidity, from about 5% to about 25% relative humidity, from about 7.5% to about 22.5% relative humidity, from about 10% to about 20% relative humidity, or from about 12.5% to about 17.5% relative humidity. In still other embodiments, the dye-discharging conditions may include an elevated temperature, for instance from about 30-90° C., such as from about 35° C. to about 85° C., from about 40° C. to about 80° C., from about 45° C. to about 75° C., from about 50° C. to about 70° C., or from about 55° C. to about 60° C. Without being bound by theory, the warm, dry environment may facilitate the release of the dye by swelling polymer particles. In embodiments, the beads and textile may be agitated together (for instance, in a tumbling drum or on a fluidized bed to facilitate Newtonian flow) to facilitate intimate contact between the beads and the textile fibers.

Following the dye-discharging step, the particles or beads may be separated from the textiles and recovered. In some embodiments, this may be accomplished using tumbling or other agitation in combination with slots, mesh, or holes in the agitation device that may be sized to permit the passage of the particles, while retaining the textile. In certain embodiments, the efficiency of the separation and particle collection may be increased by increasing the airflow through the agitation device, for instance, with a fan or blower.

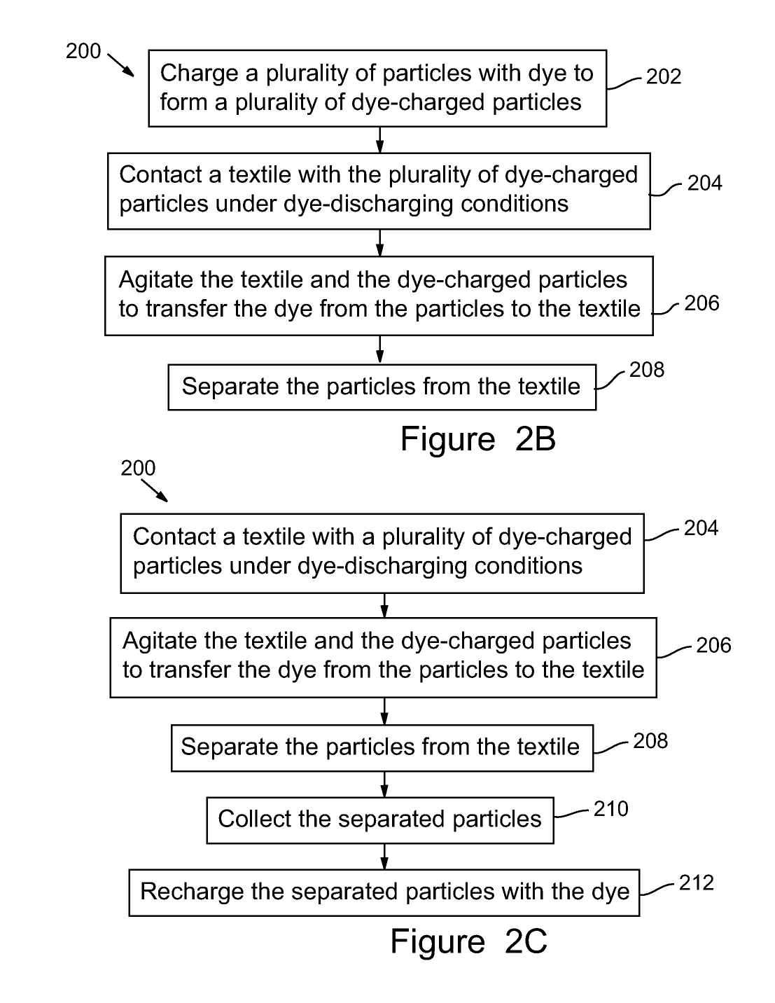

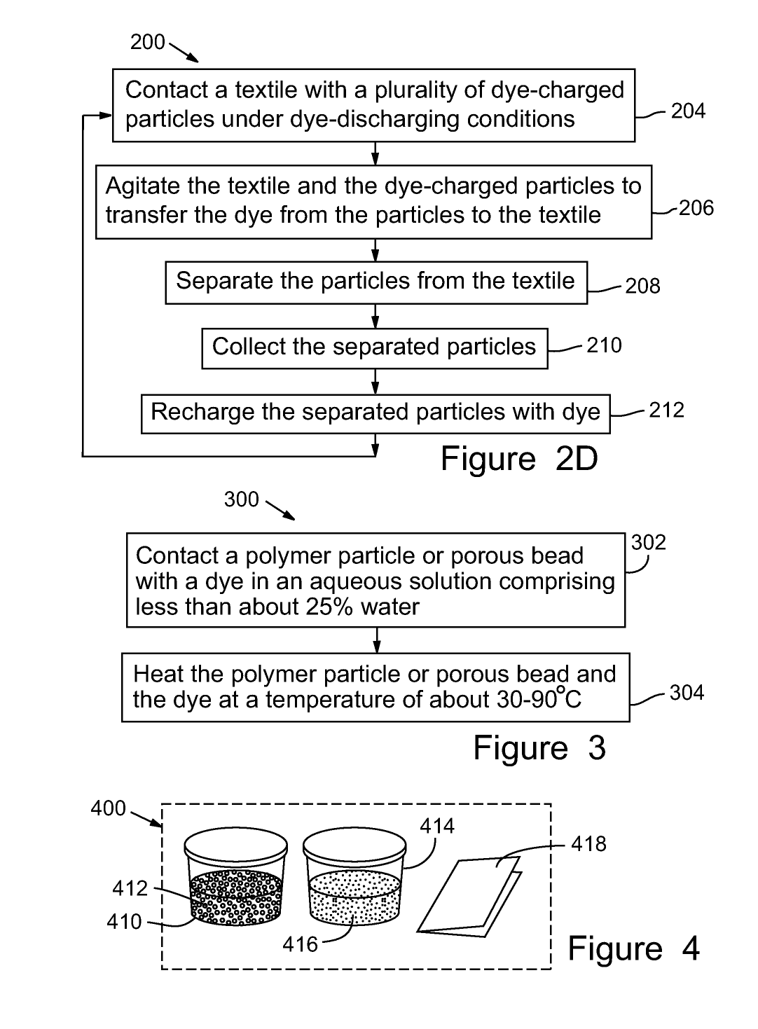

The system described above may be more clearly understood with reference to FIG. 2A, which is a flow diagram illustrating some of the operations associated with a first example method for dyeing a textile, arranged in accordance with at least some embodiments of the present disclosure. It should be noted that although the method is illustrated as a series of sequential steps, the method is not necessarily order dependent. Moreover, methods within the scope of this disclosure may include more or fewer steps than illustrated.

Turning now to FIG. 2A, with continued reference to the system described above, the method 200 may include one or more functions, operations, or actions, as is illustrated by block 204, block 206, and/or block 208. Processing for method 200 may start with block 204, (“Contact a textile with a plurality of dye-charged particles under dye-discharging conditions”) which may be performed with the particles described herein when charged with dye as illustrated in FIG. 1. For instance, as illustrated in FIG. 1, in some examples, a porous bead charged with dye (FIG. 1A), or a polymer particle charged with dye (FIG. 1B) may be used. As described elsewhere herein, such dye-discharging conditions may include, for instance, elevated temperature, low humidity, and/or moist saline conditions.

From block 204, the method 200 may proceed to block 206, (“Agitate the textile and the dye-charged particles to transfer the dye from the particles to the textile”). In embodiments, the agitation may be accomplished, for instance, in a tumbling drum or a fluidized bed, as described elsewhere herein.

From block 206, the method 200 may proceed to block 208, (“Separate the particles from the textile”). As described elsewhere herein, this step may be accomplished using tumbling or other agitation in combination with appropriately-sized slots, holes, or mesh in the agitation device that permit the passage of the particles while retaining the textile. In particular embodiments, the efficiency of the separation and particle collection may be enhanced by increasing the airflow through the device, for instance, with a blower or fan.

Another embodiment of the method 200 is depicted in FIG. 2B, which is a flow diagram illustrating some of the operations associated with a second example method for dyeing a textile, arranged in accordance with at least some embodiments of the present disclosure. It should be noted that although the method is illustrated as a series of sequential steps, the method is not necessarily order dependent. Moreover, methods within the scope of this disclosure may include more or fewer steps than illustrated.

Turning now to FIG. 2B, with continued reference to the system described above, the method 200 may include one or more functions, operations, or actions, as is illustrated by block 202, block 204, block 206, and/or block 208. In embodiments, the method may begin with block 202, (“Charge a plurality of particles with dye to form a plurality of dye-charged particles”), before proceeding to block 204, (“Contact a textile with a plurality of dye-charged particles under dye-discharging conditions”). As described elsewhere herein, the particles may be charged with dye in a dry environment, for instance with an elevated temperature, or they may be charged with dye in a moist environment. In general, the dye-charging conditions may be selected based upon the type of particles used (for instance, porous beads or polymer particles, as described above), or based on the type of dye selected (for instance, the temperature may be selected to be near, at, or higher than the melting point of the dye).

From block 204, the method 200 may proceed to block 206, (“Agitate the textile and the dye-charged particles to transfer the dye from the particles to the textile”).

From block 206, the method 200 may proceed to block 208, (“Separate the particles from the textile”).

Another embodiment of the method 200 is depicted in FIG. 2C, which is a flow diagram illustrating some of the operations associated with a third example method for dyeing a textile, arranged in accordance with at least some embodiments of the present disclosure. It should be noted that although the method is illustrated as a series of sequential steps, the method is not necessarily order dependent. Moreover, methods within the scope of this disclosure may include more or fewer steps than illustrated.

Turning now to FIG. 2C, with continued reference to the system described above, the method 200 may include one or more functions, operations, or actions, as is illustrated by block 204, block 206, block 208, block 210, and/or block 212. Processing for method 200 may start with block 204, (“Contact a textile with a plurality of dye-charged particles under dye-discharging conditions”).

From block 204, the method 200 may proceed to block 206, (“Agitate the textile and the dye-charged particles to transfer the dye from the particles to the textile”).

From block 206, the method 200 may proceed to block 208, (“Separate the particles from the textile”).

From block 208, the method 200 may proceed to block 210, (“Collect the separated particles”). As described elsewhere herein, once the particles are separated from the textile, they may be collected, for instance for disposal or for reuse.

From block 210, the method 200 may proceed to block 212, (“Re-charge the separated particles with dye”). As described above, the particles may be charged with dye in a dry environment, for instance with an elevated temperature, or they may be charged with dye in a moist environment. In general, the dye-charging conditions may be selected based upon the type of particles used (for instance, porous beads or polymer particles), or based on the type of dye selected.

Yet another embodiment of the method 200 is depicted in FIG. 2D, which is a flow diagram illustrating some of the operations associated with a fourth example method for dyeing a textile, arranged in accordance with at least some embodiments of the present disclosure. It should be noted that although the method is illustrated as a series of sequential steps, the method is not necessarily order dependent. Moreover, methods within the scope of this disclosure may include more or fewer steps than illustrated.

Turning now to FIG. 2D, with continued reference to the system described above, the method 200 may include one or more functions, operations, or actions, as is illustrated by block 204, block 206, block 208, block 210, and/or block 212. Processing for method 200 may start with block 204, (“Contact a textile with a plurality of dye-charged particles under dye-discharging conditions”).

From block 204, the method 200 may proceed to block 206, (“Agitate the textile and the dye-charged particles to transfer the dye from the particles to the textile”).

From block 206, the method 200 may proceed to block 208, (“Separate the particles from the textile”).

From block 208, the method 200 may proceed to block 210, (“Collect the separated particles”).

From block 210, the method 200 may proceed to block 212, (“Re-charge the separated particles with dye”).

From block 212, the method 200 may return to block 204, (“Contact a textile with a plurality of dye-charged particles under dye-discharging conditions”). Thus, the method may repeat one or more times as the particles are re-charged with dye in block 212 for each cycle.

The system for charging the particles with dye described above may be more clearly understood with reference to FIG. 3, which is a flow diagram illustrating some of the operations associated with an example method for charging a particle with dye, arranged in accordance with at least some embodiments of the present disclosure. It should be noted that although the method is illustrated as a series of sequential steps, the method is not necessarily order dependent. Moreover, methods within the scope of this disclosure may include more or fewer steps than illustrated.

Turning now to FIG. 3, with continued reference to the system described above, the method 300 may include one or more functions, operations, or actions, as is illustrated by block 302 and/or block 304. Processing for method 300 may start with block 302, (“Contact a polymer particle or porous bead with a dye in an aqueous solution comprising less than about 25% water”).

From block 302, the method 300 may proceed to block 304, (“Heat the polymer particle or porous bead and the dye at a temperature of about 30-90° C.”). As described above in greater detail, it is believed that elevated temperature may cause the dye to melt and may facilitate absorption of the dye (for instance, by capillary action) by the pores of the porous beads. Similarly, it is believed that warm, moist conditions facilitate dye uptake by the polymer particles.

Also disclosed herein are kits for dyeing a textile. FIG. 4 presents a schematic diagram illustrating a kit 400 for dyeing a textile, arranged in accordance with various embodiments of the present disclosure. Such a kit 400 may include, for example, a container 410 that may contain a plurality of particles 412, such as porous beads, for instance, beads made from sintered metals, clay, or controlled pore glass, or polymer particles, for instance, particles made from an IPN or a polyamide, a polyalkene, a polyester, a polyurethane, or a copolymer thereof. The kit also may include a container 414 that may contain a textile dye 416, and instructions 418 for using the kit 400.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Various operations may be described as multiple discrete operations in turn, in a manner that may be helpful in understanding embodiments; however, the order of description should not be construed to imply that these operations are order-dependent. Also, embodiments may have fewer operations than described. A description of multiple discrete operations should not be construed to imply that all operations are necessary. Also, embodiments may have fewer operations than described. A description of multiple discrete operations should not be construed to imply that all operations are necessary.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for dyeing a textile, comprising:
contacting a textile with a plurality of dye-charged particles having an average diameter of about 1 mm or greater under dye-discharging conditions;
agitating the textile and the dye-charged particles to transfer the dye from the particles to the textile; and
separating the particles from the textile.

2. The method of claim 1, wherein the particles comprise porous beads.

3. The method of claim 1, wherein the particles comprise sintered metal, clay, or controlled pore glass.

4. The method of claim 1, wherein the particles have an average pore size of from about 1 micron to about 500 microns.

5. The method of claim 4, wherein the particles have an average pore size of from about 50 microns to about 300 microns.

6. The method of claim 1, wherein the particles comprise polymer particles.

7. The method of claim 1, wherein the particles comprise a polyamide, a polyalkene, a polyester, a polyurethane, or a copolymer thereof.

8. The method of claim 1, wherein the particles comprise an interpenetrating polymer network (IPN).

9. The method of claim 1, wherein the contacting step is performed at a temperature of about 30° C. to about 90° C.

10. The method of claim 1, wherein the contacting step is performed at a relative humidity level of less than about 30%.

11. The method of claim 1, wherein the contacting step is performed at a saline-to-textile ratio of from about 0.1:1 to about 5:1 weight to weight.

12. The method of claim 1, further comprising charging a plurality of particles with dye to form the plurality of dye-charged particles.

13. The method of claim 1, further comprising:
collecting the separated particles; and
re-charging the separated particles with dye.

14. The method of claim 13, further comprising repeating the method one or more times.

15. A method of charging a particle with dye, comprising:
contacting a polymer particle or porous bead having an average diameter of about 1 mm or greater with a dye in an aqueous solution comprising less than about 25% (w/w) water; and
heating the polymer particle or porous bead and the dye at a temperature of about 30-90° C.

16. The method of claim 15, wherein the polymer particle comprises a polyalkene, a polyester, a polyurethane, or a copolymer thereof, or an interpenetrating polymer network (IPN).

17. The method of claim 15, wherein the porous bead comprises a sintered metal, a clay, or a controlled pore glass.

18. The method of claim 15, wherein the dye comprises an aqueous dye, a polyester dye, or a lipid-based dye.

19. A porous bead for use in dyeing a textile, wherein the bead is charged with an aqueous dye, a polyester dye, or a lipid-based dye, wherein the bead has a diameter of about 1 mm or greater, and wherein the bead comprises a sintered metal, a clay, or a controlled-pore glass.

20. The porous bead of claim 19, wherein the bead has an average pore size of about 1 micron to about 500 microns.

21. The porous bead of claim 20, wherein the bead has an average pore size of about 50 microns to about 300 microns.

22. A kit for dyeing a textile comprising:
a first container comprising a plurality of dye-chargeable particles having an average diameter of about 1 mm or greater; and
a second container comprising a textile dye.

23. The kit of claim 22, further comprising instructions for using the kit.

24. The kit of claim 22, wherein:
the plurality of dye-chargeable particles comprises a porous bead and the porous bead comprises a sintered metal, a clay, or a controlled pore glass.

25. The kit of claim 22, wherein:
the plurality of dye-chargeable particles comprises a polymer, and the polymer comprises a polyamide, a polyalkene, a polyester, a polyurethane, or a copolymer thereof, or an interpenetrating polymer network.

26. The kit of claim 22, wherein the textile dye comprises an aqueous dye.
